(19) United States
(12) Patent Application Publication
(10) Pub. No.: US 2006/0019574 A1
(43) Pub. Date: Jan. 26, 2006

(54) Toy with dissolving external features that reveal skeletal features

(76) Inventor: Andre G. Solomita, Ashland, MA (US)

Correspondence Address: COLLIER SHANNON SCOTT, PLLC, 3050 K STREET, NW, SUITE 400, WASHINGTON, DC, 20007, US

(21) Appl. No.: 10/894,130

(22) Filed: Jul. 20, 2004

(51) Int. Cl. A63H 3/00; A23G 3/00

(52) U.S. Cl. 446/373; 446/268; 446/385; 446/386; 426/104

(57) ABSTRACT

Toy figures having dissolving external features that reveal internal skeletal features. The toy figure may be representative of a creature such as a dinosaur, animal, human, or the like. An internal portion is configured to represent a skeleton of the creature and is composed of a material that does not readily dissolve in a given liquid, such as water. An external portion represents the external features of the creature and is composed of a material that does dissolve in the given liquid. When the toy structure is immersed in the given liquid, the external portion dissolves to reveal the skeletal features represented by the internal portion.

### BACKGROUND OF THE INVENTION

1. Field of the Invention

This invention relates generally to toys and more particularly to a toy that represents a creature having external features that dissolve to reveal internal features.

2. Description of the Related Art

A wide variety of toys including those that represent animals and other creatures are well known. Also known are toys that include multiple modes, such as those that provide a visible portion that conceals another portion that is variously revealed.

Some examples of these types of toys include outer shells that are typically comprised of multiple parts that can be assembled and disassembled. When the shell is opened, whatever may be contained within the shell is revealed. The shell shape may not manifest the shape of the item within the shell. For example, the shell may have the shape of an egg shell, with the contents being of a different shape.

The shell may also be shaped such that it is similar to the interior contents. In one example, such as described in U.S. Pat. No. 5,480,341, the toy includes an outer shell portion configured to look like the skin of a dinosaur, and a corresponding interior portion configured to look like the internal skeleton of the dinosaur. A child may manually disassemble the outer shell to reveal the inner contents. While this type of toy is useful for showing the internal portion of an animal corresponding to its outer skin, it is believed that removal and replacement of the shell may not render a full appreciation of the significance of removing the flesh of an animal. It is also believed that the toy may not be sufficiently entertaining to the child-user.

Other examples of conventional toys provide packaging that dissolves to reveal inner contents. For example, U.S. Pat. No. 5,273,476 describes a toy package that dissolves to reveal a hidden novelty item contained therein. The package may be decorated and shaped to have a particular form, but is described as being sufficiently opaque so as to preclude visual inspection of the novelty item found within the package. These examples of toy packaging emphasize the value of hiding what might be contained within the package, in light of the perceived benefits of surprising a child with a toy whose identity is hidden by the package. While this is a useful arrangement for hiding novelty items, there is essentially no educational relationship between the package and the content nor is there any indication that such would be desirable.

Thus, there remains a need for an educational and recreational toy that is sufficiently stimulating to the intended audience and that offers indicia of the relationship among elements of a creature.

### SUMMARY OF THE INVENTION

The present invention improves on existing toys in educational and recreational aspects by providing figures having dissolving external features that reveal internal skeletal features.

In one embodiment, the present invention may provide a toy structure that is representative of a vertebrate creature such as a dinosaur, animal, human, or the like. The internal portion of the toy structure is configured to represent a skeleton of the vertebrate creature and is composed of a material that does not readily dissolve in a liquid such as water. The external portion is configured to represent the external features of the vertebrate creature and is composed of a material that does dissolve in the liquid. When the toy structure is immersed in the liquid, the external portion dissolves to reveal the skeletal features represented by the internal portion.

The vertebrate creature may be a dinosaur. There, the internal portion represents the skeleton of the dinosaur and the external portion represents the flesh of the dinosaur. Human figures that are decorated to provide other types of entertainment may also be provided. In one embodiment, the toy figure is representative of a pirate that is decorated accordingly, such as by wearing a pirate hat, carrying a sword, or the like. Similarly, the external flesh related features of the figure would dissolve upon immersion of the pirate figure into the given liquid, leaving the corresponding (human) skeletal features remaining. In addition to the skeletal features, the toy may be configured to retain pirate related decorations. In this fashion, a child could immerse the original pirate figure into water to cause the dissolving process, which would reveal a skeletal pirate having a pirate hat, sword, or whatever decor is presumed to be the most entertaining or otherwise desired.

In some embodiments, the remaining internal features may extend beyond skeletal features. For example, the internal portion may also include representations of various internal organs that would remain along with the skeleton after immersion of the toy structure in the given liquid. This can provide enhanced entertainment, as it can be used to illustrate additional body features and locations of the same.

Another aspect of the present invention provides a toy structure configured to provide an edible component. In one embodiment, this can provide a treat of some form to a child. For example, the internal portion can be provided as an edible candy that does not dissolve upon immersion of the toy structure into water. This allows the entertainment and education of experiencing the dissolution of the external portion, and the added value of providing a relevant treat to be eaten after the experience.

The external portion may also be composed of edible material. Specifically, the external portion, again configured to represent external features of the creature, may also be composed of an edible (and preferably sweetened) material that readily dissolves in water. With this embodiment, immersion of the edible toy structure in water dissolves the external portion to create a potable sweet tasting liquid resulting from the solution of the water and the external portion.

In yet another aspect, the present invention can be embodied as toy set combinations that uniquely provide an environment for the dissolving action. For example, where the figure is a dinosaur, the toy set may include a volcano and a vessel for storing liquid that would be representative of lava. Immersion of the dinosaur in the given liquid emulates having the dinosaur fall into lava produced by the volcano. In another example, the figure may be a pirate. The toy set might include a pirate ship that floats in water. A child might have the pirate “walk the plank” or otherwise have the figure fall into the water to prompt dissolving of the external portion.

The present invention can be embodied in various forms, including methods, business processes, systems and articles of manufacture including toys sets and toys, and others.

### BRIEF DESCRIPTION OF THE DRAWINGS

These and other more detailed and specific features of the present invention are more fully disclosed in the following specification, reference being had to the accompanying drawings, in which:

FIGS. 1A-C are perspective views depicting an external portion, immersion in a liquid, and an internal portion for a toy structure in accordance with the present invention.

FIG. 2 is a perspective view of an embodiment of a toy set including a toy structure in accordance with the present invention.

FIG. 3 is a perspective view of another embodiment of a toy set including a toy structure in accordance with the present invention.

### DETAILED DESCRIPTION OF THE INVENTION

In the following description, for purposes of explanation, numerous details are set forth, such as flowcharts and system configurations, in order to provide an understanding of one or more embodiments of the present invention. However, it is and will be apparent to one skilled in the art that these specific details are not required in order to practice the present invention.

As introduced above, the present invention may be embodied as a toy structure that is representative of a vertebrate creature such as a dinosaur, animal, human, or the like. The internal portion of the toy structure is configured to represent a skeleton of the vertebrate creature and is composed of a material that does not readily dissolve in a given liquid, such as water. The external portion is configured to represent the external features of the vertebrate creature and is composed of a material that does dissolve in the given liquid. When the toy structure is immersed in the given liquid, the external portion dissolves to reveal the skeletal features represented by the internal portion.

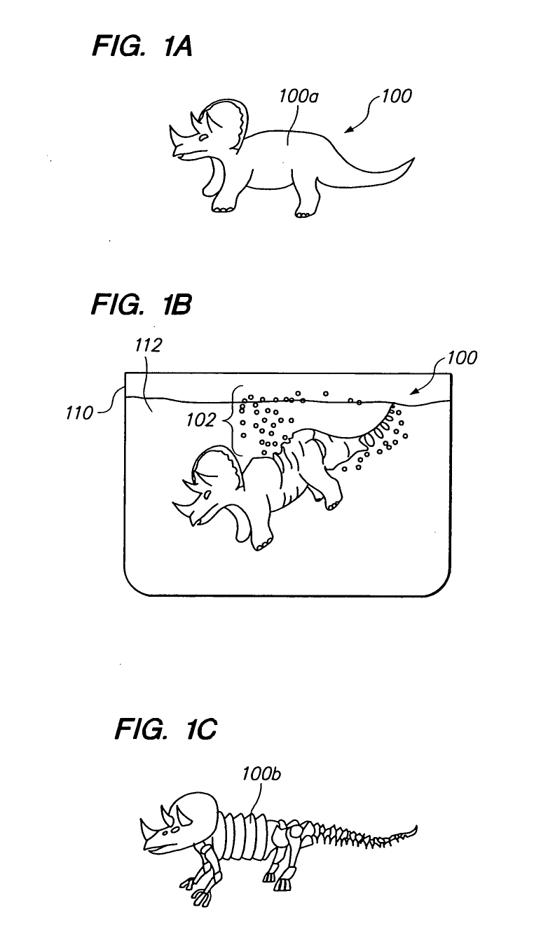

FIGS. 1A-C are perspective views respectively illustrating the external 100a and internal portions 100b of one embodiment of a toy structure 100, as well as the process of dissolving the external portion 100a pursuant to placing the toy structure 100 in a liquid in accordance with the present invention.

The example of FIGS. 1A-C is of a toy structure 100 that is representative of a dinosaur, more particularly a triceratops. In that regard, the external portion 100a is configured to be representative of the features of a triceratops that would be presumed visible were someone to view a live triceratops. Depending upon the type of creature being depicted, various features will be visible as part of the external portion. For the triceratops, these features include the eyes, horns, frill, legs, and tail. Additionally, the skin will generally provide the outermost surface of the external portion, and can be variously provided as desired.

There are various alternatives for the external portion of the toy structure 100. For example, the features do not necessarily have to be life-like, and can even be intentionally incorrect. For example, where the toy structure 100 is a dinosaur, it may include reptile-like green skin, or some other color or even a fanciful combination of colors such as a rainbow. The external portion may also include unrealistic, fanciful features such as glitter, and may include exaggerated features such as excessively large horns, long legs or other features deemed to be desirable by the designer. Of course, other types of dinosaurs including but not limited to a tyrannosaurus, apatosaurus, stegosaurus, or velociraptor may be provided.

The present invention is not limited to dinosaurs. Other creatures including extinct or present day animals, human figures, or others may be provided. Still further, the toy structure may comprise a fictional character such as a fire breathing dragon, an alien, a robotic “terminator” type creature, or any number of alternatives.

In the pre-dissolved state, the toy structure may also be configured to include decorations beyond the perceived natural state of the creature. For example, the toy figure may be a human dressed as a pirate, including pirate clothing as well as accessories such as a sword or pirate hat.

Referring now to FIG. 1B, the toy FIG. 100 may then be immersed in a liquid 112 such as one provided in a container 110. Preferably, the external portion 100a is configured to readily dissolve in the liquid as depicted by the pieces 102 of the external portion 100a shown to be dispersing into the liquid 112. This depiction is illustrative. The pieces of the external portion 100a that dissolve into the liquid 112 may or may not actually be visible when the process occurs. Although water is a convenient and safe liquid for the process, any number and type of substitute liquids may be used, as described further below.

The internal portion 100b is composed of a material that does not readily dissolve in the liquid 112. Therefore, the dissolving process continues until the external portion 100a is removed, leaving only an internal portion 100b of the toy structure 100 as illustrated in the perspective view of FIG. 1C.

Preferably, the creature that the toy structure 100 depicts is some type of vertebrate creature (real or fictional), wherein the internal skeletal portion corresponds generally to the external portion. For example, the illustrated internal portion 100b is a triceratops skeleton that has various features (limbs, horns, frill, tail, etc.) that generally correspond to the external features provided by the external portion 100a. By providing external features that dissolve to reveal an internal skeleton, it is believed that a superior entertainment and educational experience is provided in accordance with this embodiment of the present invention, as the erosion of the external features of the creature to reveal the skeleton can provide a dramatic and memorable experience. The internal portion 100b may be a solid unitary construction or may be made of parts that can be assembled and disassembled.

Although in one embodiment a skeleton solely remains after the dissolving process, other features may remain depending upon the type of creature being represented and the desires of the designer. For example, where the toy figure is a pirate, some decorations such as clothing, a pirate hat, and/or a sword may remain along with the skeleton even though such decorations are observable along with the external portion prior to the dissolving process. Additionally, again in the example of a pirate, for increased dramatic effect the result after the dissolving process may leave what appears to be some rotting or decomposing flesh on the skeleton. In another alternative, internal organs such as the heart, liver kidneys, lungs, etc. may remain after the dissolving process.

In one embodiment, the internal portion 100b may be composed of a plastic dinosaur skeleton similar to those provided for purchase in that form by various museums and toy stores. The external portion 100a can be sculpted around the so provided internal portion 100b using a pliable material that dissolves in water. An example of such a material can be composed of an effervescent antacid such as one containing sodium bicarbonate and tartaric acid (e.g., BRIOSCHI™). The antacid material is ground into a fine powder and mixed with corn syrup to bind the material together, enough to provide the desired consistency. The material is then worked about the internal portion 100b, and using manual pressure and sculpting the external features of the dinosaur are configured. Dissolvable paints or food coloring may be used to provide a desired color or other external features.

According to another aspect, the internal portion may include glow in the dark features. The external portion may be transparent or semi-transparent to accommodate viewing the glow in the dark features prior to dissolution of the external portion.

The toy structure may also be provided as a kit, wherein the internal portion and the external portion are assembled together by the user. In one embodiment, this is provides as a pre-formed internal portion and pliable material that is used to provide the external portion. Molds shaped in the form of the external portion may also be provided to ease user assembly.

The present invention is not limited as to the type of materials for the internal and external portions described above, the process for making the toy structure, or the type of liquid used for dissolving the external portion.

There are a variety of well known materials that can be used for the internal and external portions, as well as a variety of well known processes for providing the external portion, any of which can be used to provide embodiments of the present invention. For example, a high production compression or injection molding process may be used for the internal portion, the external portion, and/or the process of providing the external portion in conjunction with the internal portion as a toy structure. Various plastic materials including polyolefins, nylons, ultra high molecular weight polymers, and others may be used. Generally, the internal portion may be composed of any material that does not readily dissolve in the given liquid, such as those described above, metal, wood, bone, or any other type of material that does not readily dissolve.

Various alternative compositions and processes may also be used for the external portion. Generally any material that does dissolve in the given liquid can be used. Examples include sugar and a binding agent, a gelatin based material such as described in U.S. Pat. No. 6,090,915, cellulose based materials, and any other number of materials configured to dissolve in the desired type of liquid. The external portion may or may not also implement various alternative types of effervescent material to provide a fizzing activity upon immersion into the given liquid, such as compressed carbon dioxide that is encapsulated within material, but which escapes with the dissolving action of the external portion material, or any type of material that reacts with the liquid to create a similar action.

Although water is preferred, other liquids such as vinegar (e.g., to vigorously interact with a baking soda based coating), acetone, alcohol, or other liquids may alternatively provide the liquid in which the external portion is intended to dissolve.

Another aspect of the present invention provides a toy structure configured to provide an edible component. This can provide a treat of some form to a child. For example, the internal portion can be provided as candy that does not dissolve upon immersion of the toy structure into water. This allows the entertainment and education of experiencing the dissolution of the external portion, and the added value of providing a relevant treat to be eaten after the experience.

Other embodiments according to this aspect are related to the external portion. Specifically, the external portion, again configured to represent external features of the creature, may also be composed of an edible (and preferably sweetened) material that readily dissolves in water. With this embodiment, immersion of the edible toy structure in water dissolves the external portion to create a potable sweet tasting liquid resulting from the solution of the water and the external portion.

For this embodiment, the external portion may be formed using a combination of sugar, coloring, flavoring and powdered starch or other binding ingredient. The mixture is configured to readily dissolve in water, which results in a drinkable, sweetened liquid. An effervescent material may also be added to provide a “fizzy” drink (e.g., the material may be based upon Pop Rocks™ candy or the like) which may heighten the entertainment effect, or the product may be configured to be dissolved into a carbonated beverage such as seltzer water to accommodate the same effect. The internal portion may be provided as a conventional hard candy that is formed by conventional candy making processes or mechanically (e.g., manually or automatically) configured following formation of a base piece of candy. As with other embodiments, any conventional material or combination of materials may be used depending upon the desires or needs of the designer. The only requirement for this embodiment is that the materials result in something edible.

In yet another aspect, the present invention can be embodied as toy set combinations that uniquely provide an environment wherein the dissolving action will occur, for still further entertainment value. For example, where the figure is a dinosaur, the toy set may include a volcano and a vessel for storing liquid that would be representative of lava. Immersion of the dinosaur in the given liquid emulates having the dinosaur fall into lava produced by the volcano.

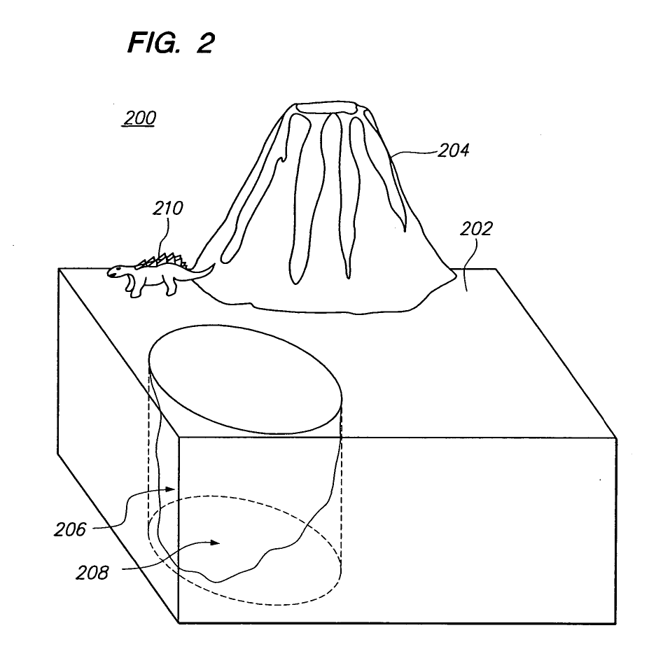

This aspect is illustrated in the perspective view of an embodiment of such a toy set 200 of FIG. 2. The toy set 200 includes a base 202 that provides the general landscape corresponding to the environment. It is shown as a rectangular piece, but it may of course include irregular surfaces, trees, coloring and other items that could depict a desired setting. The base 200 also includes a replica of a volcano 204 that is decorated as desired, such as to indicate active lava flow from the volcano 204. The base 200 is constructed of an opaque plastic material, but includes a cutaway section 206 that is preferably constructed of a transparent material such as transparent plastic. A removable interior container 208 is configured for placement in an aperture in the base. The removable interior container 208 is also transparent, and the aperture is located such that a person can view into the container through the transparent materials of the base and the container. A toy FIG. 210 substantially as previously described is provided with the toy set 200. The container 208 is filled with liquid, such as water. When placed in the base 202, the pool of water provided by the container 208 may be configured to emulate lava that may have been produced from the volcano 204. A child may play with the toy FIG. 210 on the landscape provided by the base 200. When desired, the child may cause the toy FIG. 210 to fall into the “lava” pool held by the container 208, which would prompt the dissolving process and provide an entertaining emulation of the creature falling into lava and having its flesh melt to reveal a skeletal structure.

The toy set 200 is not limited to this environment, nor is the volcano-related embodiment limited to the depiction of FIG. 2. For example, the dissolving action may be arranged to take place within the volcano, with perhaps a relatively large opening for the volcano vent to accommodate entry of the dinosaur and a viewing section within the volcano cone or within the magma reservoir below the cone.

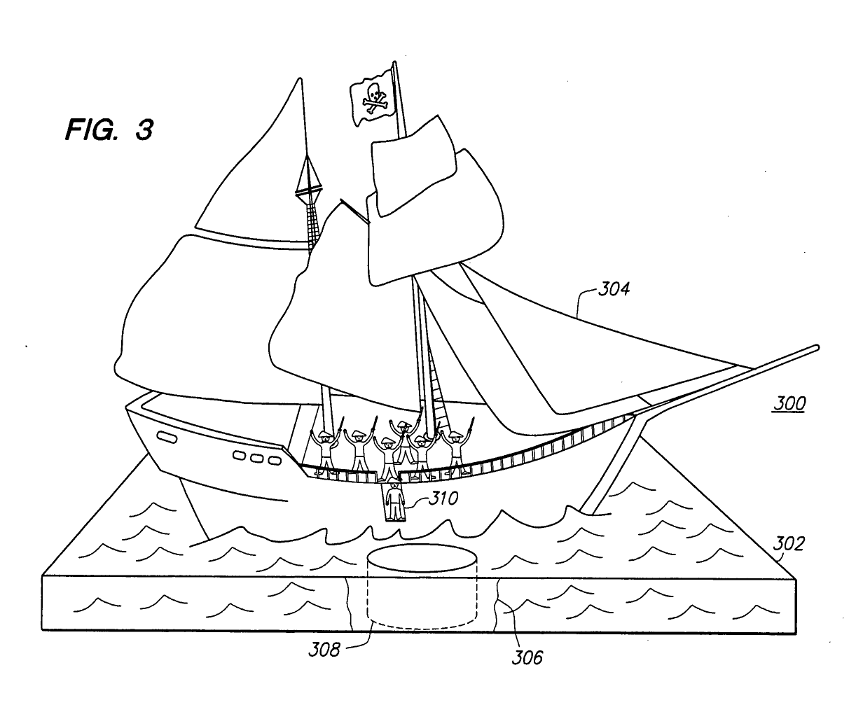

In another example, the figure may be a pirate. The toy set might include a pirate ship that floats in water. A child might have the pirate “walk the plank” or otherwise have the figure fall into the water to prompt dissolving of the external portion. FIG. 3 illustrates a toy set 300 embodiment consistent with this scenario. Here, the toy set 300 includes a base 302 that is configured to emulate an oceanic environment. A replica of a pirate ship 304 is configured to be floating in the sea. Again, the base 302 is constructed of an opaque plastic material with a transparent cutaway section 306, and a removable interior container 308 configured for placement in an aperture in the base, all arranged to accommodate viewing the internal compartment of the container 308 while it is placed in the aperture to reside within the base 302. Again, the toy FIG. 310 is as previously described, particularly decorated as a pirate character. Water is placed in the container 308, which is placed in the base 302 aperture, in an entertaining location such as beneath a plank extending from the pirate ship 304. When desired, a toy set 300 user such as a child may cause the toy FIG. 310 to walk along the plank and fall into the water held by the container 308, which would prompt the dissolving process and provide an entertaining emulation of the pirate character falling into the sea, with dissolving to reveal a skeletal structure.

Thus embodiments of the present invention provide a toy structure and related toy sets and processes. Although the present invention has been described in considerable detail with reference to certain embodiments thereof, the invention may be variously embodied without departing from the spirit or scope of the invention. Therefore, the following claims should not be limited to the description of the embodiments contained herein in any way.

1. A toy structure representative of a vertebrate creature, the toy structure comprising:
an internal portion, configured to represent a skeleton of the vertebrate creature and composed of a material that does not readily dissolve in a given liquid; and
an external portion, configured to represent the external features of the vertebrate creature and composed of a material that dissolves in the given liquid, whereby immersion of the toy structure in the given liquid causes the external portion to dissolve and reveal the internal portion.

2. The toy structure of claim 1, wherein the vertebrate creature is a dinosaur, such that the internal portion represents the skeleton of the dinosaur and the external portion represents the flesh of the dinosaur.

3. The toy structure of claim 2, wherein the given liquid is water.

4. The toy structure of claim 1, wherein the vertebrate creature is a human, such that the internal portion represents the skeleton of the human and the external portion represents the flesh of the human.

5. The toy structure of claim 1, wherein the human is decorated as a pirate.

6. The toy structure of claim 5, wherein the pirate decoration includes a pirate feature that does not dissolve in the given liquid, whereby immersion of the toy structure in the given liquid results in a human skeleton decorated with the pirate feature.

7. The toy structure of claim 6, wherein the pirate feature is a sword.

8. The toy structure of claim 6, wherein the internal portion also represents decomposing flesh of the human that remains along with the skeleton of the human after immersion of the toy structure in the given liquid.

9. The toy structure of claim 1, wherein the internal portion also represents internal organs that remain along with the skeleton after immersion of the toy structure in the given liquid.

10. The toy structure of claim 9, wherein the internal portion is composed of a set of parts that can be disassembled and reassembled.

11. The toy structure of claim 1, wherein the internal portion is composed of a set of parts that can be disassembled and reassembled.

12. The toy structure of claim 1, wherein dissolving the external portion in the given liquid results in a potable liquid.

13. The toy structure of claim 12, wherein the internal portion is edible candy.

14. An edible toy structure representative of a creature, the edible toy structure comprising:
an internal portion, configured to represent internal elements of the creature and composed of a material that does not readily dissolve in water; and
an external portion, configured to represent external features of the creature and composed of an edible sweetened material that readily dissolves in water, whereby immersion of the edible toy structure in water dissolves the external portion, creates a potable sweet tasting liquid resulting from the solution of the water and the external portion, and reveals the internal portion.

15. The edible toy structure of claim 14, wherein the creature is a dinosaur, with the internal portion representing the dinosaur skeleton and the external portion representing the dinosaur flesh.

16. The edible toy structure of claim 14, wherein the internal portion material comprises edible candy.

17. A toy set combination, comprising:
an environmental structure that provides an environment that entails the presence of a liquid that is represented by a given liquid; and
a toy structure, comprising:
an internal portion, configured to represent a skeleton of the vertebrate creature and composed of a material that does not readily dissolve in a given liquid; and
an external portion, configured to represent the external features of the vertebrate creature and composed of a material that dissolves in the given liquid, whereby immersion of the toy structure in the given liquid causes the external portion to dissolve and reveal the internal portion.

18. The toy set combination of claim 17, wherein the environmental structure includes a volcano, the liquid is lava, and the vertebrate creature is a dinosaur, such that immersion of the dinosaur in the given liquid emulates having the dinosaur fall into lava produced by the volcano.

19. The toy set combination of claim 18, wherein the given liquid is water.

20. The toy set combination of claim 17, wherein the environmental structure includes a pirate ship, the liquid is a body of water that the pirate ship navigates, and the vertebrate creature is a human decorated as a pirate.
